(19) United States
(12) Patent Application Publication
(10) Pub. No.: US 2007/0270543 A1
(43) Pub. Date: Nov. 22, 2007

(54) Water-Dispersible Highly Functional polyisocyanates

(75) Inventors: Eva Wagner, Speyer (DE); Bernd Bruchmann, Freinsheim (DE); Rainer Koniger, Clifton Park, NY (US); Harald Schafer, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/574,674

(22) PCT Filed: Sep. 17, 2005
(86) PCT No.: PCT/EP05/10056

§ 371 Date: Mar. 5, 2007

(30) Foreign Application Priority Data
Sep. 23, 2004 (DE) 10 2004 046 508.8

(51) Int. Cl. C08G 18/28; B01F 3/08; C08G 18/72

(52) U.S. Cl. 524/590; 528/44; 528/67

(57) ABSTRACT

Water-dispersible, high-functionality, highly branched or hyperbranched polyisocyanates, process for preparing them and their use.

The present invention relates to water-dispersible, high-functionality, highly branched or hyperbranched polyisocyanates having a specific structure, a process for preparing them and their use.

Dendritic and high-functionality, highly branched or hyperbranched polyisocyanates have been described in the literature.

WO 97102304 describes dendrimers, but without indicating how these can be made water-dispersible,

WO 98/52995 likewise describes dendrimers, but without stating how these can be made water-dispersible over a wide pH range.

EP-A 1 134 246 and EP-A 1 134 247 describe high-functionality polyisocyanates. General ways of making these hydrophilic or hydrophobic or transfunctionalizing them are proposed, but without any explicit technical teachings being given on the subject.

EP-A 1 167 413 and EP-A 1 026 185 describe high-functionality polyisocyanates. These are made water-soluble or -emulsifiable by means of adducts having acid groups or tertiary amine groups, but these have an emulsifying action in water only in the alkaline range or in the acid range.

It is therefore an object of the present invention to provide water-dispersible, high-functionality polyisocyanates which have a specific structure and owing to their defined structure can combine advantageous properties such as high functionality high reactivity, low viscosity and/or good solubility and should be dispersible over a wide pH range, and also a process for preparing such polyisocyanates. The coatings obtained using such polyisocyanates should have a high hardness and at the same time a low brittleness.

This object is achieved by a process for preparing water-dispersible, high-functionality, highly branched or hyperbranched polyisocyanates, which comprises the reaction steps
(i) preparation of an addition product (A) containing one or more isocyanate groups and at least one group which is reactive toward isocyanate groups by reacting a
(I) (a1) diisocyanate and/or
(I) (a2) polyisocyanate
   with
(b1) at least one compound having at least three groups which are reactive toward isocyanate groups and/or
(b2) at least one compound having two groups which are reactive toward isocyanate groups,

where at least one of the components (a) or (b) has functional groups which have differing reactivities toward the functional groups of the other component and

the reaction ratio is selected so that the addition product (A) comprises on average at least one group which is reactive toward isocyanate groups and one or more isocyanate groups,
(ii) if appropriate, intermolecular addition reaction of the addition product (A) from (i) to form a polyaddition product (P) which comprises one or more isocyanate groups and can comprise at least one group which is reactive toward isocyanate groups,
(iii) if appropriate, reaction of the addition product (A) from (i) and/or the polyaddition product (P) from (ii) if this comprises at least one group which is reactive toward isocyanate groups with a monofunctional isocyanate, and/or
(iv) if appropriate, reaction of the addition product (A) from (i) and/or the polyaddition product (P) from (ii) if this comprises at least one group which is reactive toward isocyanate groups with at least one diisocyanate or polyisocyanate (I)(a1) or (1)(a2) and/or at least one diisocyanate or polyisocyanate (II) which is different from the diisocyanate or polyisocyanate (I) and
(v) reaction of the addition product (Al from (i) and/or the polyaddition product (P) from (ii) and/or the reaction product from (iii) and/or (iv) with a monofunctional polyalkylene oxide polyether alcohol,

The steps (ii), (iii), (iv) and (v) can follow the step (i) in any order. The steps (ii), (iii) and (iv) are optional, and the step (i) can, if appropriate, also be carried out a number of times.

Possible reaction step sequences are, for example,

(i)-(v), (i)-(ii)-(v), (i)-(v)-(ii), (i)-(iii)-(v), (i)-(v)-(iii), (i)-(iv)-(v), (i)-(v)-(iv), (i)-(ii)-(iii)-(v), (i)-(ii)-(v)-(iii), (i)-(iii)-(ii)-(v), (i)-(iii)-(v)-(ii), (i)-(v)-(ii)-(iii), (i)-(v)-(iii)-(ii), (i)-(ii)-(iv)-(v), (i)-(ii)-(v)-(iv), (i)-(iv)-(ii)-(v), (i)-(iv)-(v)-(ii), (i)-(v)-(ii)-(iv), (i)-(v)-(iv)-(ii), (i)-(iii)-(iv)-(v), (i)-(iii)-(v)-(iv), (i)-(iv)-(iii)-(v), (i)-(iv)-(v)-(iii), (i)-(v)-(iii)-(iv), (i)-(v)-(iv)-(iii), (i)-(v)-(ii)-(iii)-(iv), (i)-(ii)-(v)-(iii)-(iv), (i)-(ii)-(iii)-(v)-(iv) or (i)-(ii)-(iii)-(iv)-(v).

Work-up steps or purification steps, for example extraction, washing, stripping, distillation or filtration, can take place between any of the individual reaction steps. If necessary, the reaction mixture can be subjected to decolorization, for example by treatment with activated carbon or metal oxides such as aluminum oxide, silicon oxide, magnesium oxide, zirconium oxide, boron oxide or mixtures thereof, in amounts of, for example, 0.1-50% by weight, preferably from 0.5 to 25% by weight, particularly preferably 1-10% by weight, at temperatures of, for example, from 10 to 100° C., preferably from 20 to 80° C. and particularly preferably from 30 to 60° C., This can be achieved by addition of the pulverulent or granular decolorizing agent to the reaction mixture and subsequent filtration or by passing the reaction mixture over a bed of the decolorizing agent in the form of any suitable shaped bodies.

However, in a preferred embodiment of the present invention, the individual reaction steps are carried out in the same reactor, particularly preferably without intermediate work-up or purification steps. In this case, work-up or purification is carried out, if appropriate, only after the last reaction step (v).

The invention further provides the water-dispersible, high-functionality, highly branched or hyperbranched polyisocyanates prepared by this process.

For the purposes of the present patent application, the term “dispersion” is used as an overall term as defined in Römpp Chemie Lexikon—CD Version 1.0, Stuttgart/New York: Georg Thieme Verlag, 1995, and includes emulsions, suspensions and solutions.

Furthermore, it is also possible to make dendritic polyisocyanates water-dispersible by means of the process of the invention.

The invention further relates to the use of the water-dispersible, high-functionality, highly branched or hyperbranched polyisocyanates of the invention as building blocks for producing paints and varnishes, coatings, Coil coatings, adhesives, sealants, pourable elastomers or foams and polyaddition products obtainable using the water-dispersible, high-functionality, highly branched or hyperbranched polyisocyanates of the invention.

The water-dispersible, high-functionality, highly branched or hyperbranched polyisocyanates of the invention can also be used for impregnating leather or textiles, Substrates for impregnation are, for example, synthetic or natural fibers or woven fabrics or nonwovens made therefrom.

Hyperbranched polyisocyanates can, on the one hand, be built up from a central molecule in a manner analogous to dendrimers but with a nonuniform chain length of the branches. On the other hand, they can also have a linear structure with functional side groups or else, as a combination of the two extremes, have linear and branched parts of the molecule. For the definition of dendritic and hyperbranched polymers, see also P. J. Fiery, J. Am. Chem. Soc, 1952, 74, 2718 and H. Frey et al., Chemistry—A European Journal, 2000, 6, No. 14, 2499.

For the purposes of the present invention, “hyperbranched” means that the degree of branching (DB), i.e. the mean number of dendritic linkages plus the mean number of end groups per molecule, is from 10 to 99.9%, preferably from 20 to 99%, particularly preferably 20-95%.

For the purposes of the present invention, the term “dendritic” means that the degree of branching is 99.9-100%. For the definition of the degree of branching, see H. Frey et al., Acta Polym. 1997, 48, 30 -3.

For the purposes of the present invention, a high-functionality polyisocyanate is a polyisocyanate having at least three, preferably at least five, more preferably at least six, free isocyanate groups. There is in principle no upper limit to the number of isocyanate groups, but polyisocyanates having a very large number of isocyanate groups can have undesirable properties, for example high viscosity or poor solubility. The high-functionality polyisocyanates of the present invention usually have not more than 100 isocyanate groups, preferably not more than 50 isocyanate groups.

The polyisocyanates of the invention can also comprise groups which are reactive toward isocyanate groups, on average, for example, from 0 to 20, preferably from 0 to 15, particularly preferably from 0 to 10, very particularly preferably from 0 to 5 and in particular from 0 to 3.

The polyisocyanates of the invention have a molecular weight M_{w} of at least 500 g/mol, preferably at least 600 g/mol and particularly preferably 750 g/mol. The upper limit to the molecular weight M_{w} is preferably 100 000 g/mol; M_{w} is particularly preferably not more than 80 000 g/mol and very particularly preferably not more than 30 000 g/mol.

The figures given for the polydispersitity and for the number average and weight average molecular weights Mₙ and M_{w} are based on measurements by gel permeation chromatography using polymethyl methacrylate as standard and tetrahydrofuran as eluent. The method is described in the Analytiker Taschenbuch, Vol. 4, pages 433 to 442, Berlin 1984.

The polydispersity of the polyisocyanates of the invention is from 1.1 to 50, preferably from 1.2 to 40, particularly preferably from 1.3 to 30 and very particularly preferably from 1.5 to 10.

The polyisocyanates of the invention usually have a very good solubility, i.e. clear solutions having a content of up to 50% by weight, in some cases even up to 80% by weight, of the polyisocyanates of the invention in acetone, 2-butanone, tetrahydrofuran (THF), ethyl acetate, n-butyl acetate and numerous other solvents can be prepared at 25° C. without gel particles being detectable with the naked eye. This indicates the low degree of branching of the polyisocyanates of the invention.

As diisocyanates and polyisocyanates (I), it is possible to use the aliphatic, cycloaliphatic and aromatic isocyanates known from the prior art.

Diisocyanates (a1) are isocyanates which have a functionality of 2, i.e, two isocyanate groups per molecule, Polyisocyanates (a2) are isocyanates which have on average more than 2 NCO groups, preferably on average at least 3 NCO groups, per molecule.

Preferred diisocyanates or polyisocyanates (I) are diphenylmethane 2,4′- and 4,4′-diisocyanate (MDI), mixtures of monomeric diphenylmethane diisocyanates and higher homologous of diphenylmethane diisocyanate (polymeric MDI), tetramethylene diisocyanate, tetramethylene diisocyanate trimers, hexamethylene diisocyanate, hexamethylene diisocyanate trimers, isophorone diisocyanate trimer, 2,4′- and 4,4′-methylenebis(cyclohexyl isocyanate), xylylene diisocyanate, tetramethylxylylene diisocyanate, dodecyl diisocyanate, lysine alkyl ester diisocyanate, where alkyl is C₁-C₁₀-alkyl, 2,2,4- or 2,4,4-trimethyl-1,6-hexamethylene diisocyanate, 1,4-diisocyanatocyclohexane, 1,3- or 1,4-bis(isocyanatomethyl)cyclohexane or 4-isocyanatomethyl-1,8-octamethylene diisocyanate or 3 (or 4), 8 (or 9)-bis(isocyanatomethyl)tricyclo5.2.1.0^{2.6}]decane isomer mixtures.

Particular preference is given to diisocyanates or polyisocyanates having NCO groups of differing reactivities, e.g. tolylene 2,4-diisocyanate (2,4-TDI), diphenylmethane 2,4′-diisocyanate (2,4′-MDI), triisocyanatotoluene, isophorone diisocyanate (IPDI), 2-butyl-2-ethylpentamethylene diisocyanate, 2-isocyanatopropylcyclohexyl isocyanate, 3(4)-isocyanatomethyl-1-methylcyclohexyl isocyanate, 1,4-diisocyanato-4-methylpentane, 2,4′-methylenebis(cyclohexyl isocyanate) and 4-methylcyclohexane 1,3-diisocyanate (H-TDI).

For the purposes of the present invention, differing reactivities means that the reactivity difference between the differentiable reactive groups within the molecule under the reaction conditions is such that the quotient k₁/k₂ of the rate constants k₁ and k₂ of the respective reactive groups for the reaction con erred is at least 1.25, preferably at least 1.5, particularly preferably at least 2, very particularly preferably at least 2.5 and in particular at least 3.

Particular preference is also given to isocyanates whose NCO groups initially have the same reactivity, but in which initial addition of an alcohol, mercaptan or amine to one NCO group results in a decrease in the reactivity of the second NCO group. Examples are isocyanates whose NCO groups are coupled via a delocalized electron system e.g. 1,3- and 1,4-phenylene diisocyanate. 1,5-naphthylene diisocyanate biphenyl diisocyanate, tolidine diisocyanate and tolylene 2,6-diisocyanate.

As diisocyanates and polyisocyanates (II), it is possible to use all aliphatic, cycloaliphatic and aromatic isocyanates known from the prior art Apart from the abovementioned diisocyanates and polyisocyanates (I) it is also possible to use, for example, oligoisocyanates or polyisocyanates which can be prepared from the diisocyanates or triisocyanates mentioned or mixtures thereof by linkage via urethane allophanate, urea, biuret, uretdione, amide, isocyanurate, carbodimide, uretonimine, oxadiazinetrione or iminooxadiazinedione structures.

However, the diisocyanate or polyisocyanate (II) used in the reaction according to the invention is a different diisocyanate or polyisocyanate than the diisocyanate or polyisocyanate (I) used in step (i).

In a preferred embodiment, the compound (I) is a diisocyanate (a1) having a functionality of 2 and the compound (II) is an isocyanate having a functionality of more than 2, preferably at least 2.5, particularly preferably at least 2.8 and very particularly preferably at least 3.

As diisocyanates and polyisocyanates (II) particular preference is given to using diphenylmethane 2,4′- and 4,4′-diisocyanate, mixtures of diphenylmethane diisocyanates and higher homologues of diphenylmethane diisocyanate (polymeric MDI), 1,3- and 1,4-phenylene diisocyanate, 4-isocyanatomethyl-1,8-octamethylene diisocyanate, hexamethylene diisocyanate, oligomers of hexamethylene diisocyanate or isophorone diisocyanate (IPDI) which contain isocyanurate, uretdione, urethane, allophanate, iminooxadiazinedione or biuret groups, oligomers of MDI which contain urethane, allophanate, carbodiimide or uretonimine groups or oligomers of TDI which contain urethane, allophanate, carbodiimide or uretonimine groups.

Mixtures of the abovementioned isocyanates can also be used both for the diisocyanates and polyisocyanates (I) and for the diisocyanates and polyisocyanates (II).

Possible monoisocyanates are, for example, phenyl isocyanate, o-, m- or p-tolyl isocyanate, naphthyl isocyanate, phenylsulfonyl isocyanate, toluenesulfonyl isocyanate, butyl isocyanate, hexyl isocyanate, cyclohexyl isocyanate or dodecyl isocyanate. Preference is given to using phenyl isocyanate, toluenesulfonyl isocyanate and cyclohexyl isocyanate.

The way in which the monoisocyanates, diisocyanates and polyisocyanates (I) or (II) used according to the invention have been prepared, i.e. whether they have been obtained via a phosgenation process or a phosgene-free process, is of no great importance.

The compounds (b1) having at least three groups which are reactive toward isocyanate groups used in the preparation of the addition product (A) and the compounds (b2) having the two groups which are reactive toward isocyanate groups used in the step are selected from among compounds which have hydroxy groups, mercapto groups and/or amino groups. Preference is given to hydroxy and/or amino groups and particular preference is given to hydroxy groups.

In a preferred embodiment, the compounds (b1) having at least three groups which are reactive toward isocyanate groups preferably have 3-6, particularly preferably 3-5, very particularly preferably three or four, groups which are reactive toward isocyanate groups.

The preparation of the addition product (A) can likewise be carried out using compounds (b1) having at least three groups which are reactive toward isocyanate groups and/or compounds (b2) having two groups which are reactive toward isocyanate groups which are selected from the abovementioned functional groups or mixtures thereof and whose functional groups have differing reactivities toward NCO groups. Preference is given to compounds having at least one primary hydroxy group and at least one secondary or tertiary hydroxy group, at least one hydroxy group and at least one mercapto group or at least one hydroxy group and at least one amino group in the molecule, since the reactivity of the amino group in the reaction with isocyanate is generally significantly higher than that of the hydroxy group,

Preference is also given to compounds which are reactive toward isocyanate groups and whose isocyanate-reactive functional groups initially have the same reactivity but in which addition of at least one isocyanate results in a decrease in the reactivity of the remaining groups which are reactive toward isocyanate groups due to steric or electronic influences This is the case, for example, when trimethylolpropane or pentaerythritol is used as component (b1).

Examples of (b1) compounds having at least three groups which are reactive toward isocyanate groups are glycerol, trimethylolmethane, trimethylolethane, trimethylolpropane, 1,2,4-butanetriol, tris(hydroxymethyl)aminomethane, tris(hydroxyethyl)aminomethane, 2-amino-1,3-propanediol, 2-amino-2-methyl-1,3-propanediol, diethanolamine, dipropanolamine, diisopropanolamine, ethanolpropanolamine, bis(aminoethyl)amine, bis(aminopropyl)amine, tris(aminoethyl)amine, tris(aminopropyl)amine, trisaminononane, tris-(2-hydroxyethyl) isocyanurate, pentaerythritol, dipentaerythritol, bis(trimethylolpropane), sugar alcohols such as sorbitol, mannitol, diglycerol, threitol, erythritol, adonitol (ribitol), arabitol (lyxitol), xylitol, dulcitol (galactitol), maltitol, isomaltitol, or sugars such as glucose, trifunctional or higher-functional polyetherols based on trifunctional or higher-functional starter molecules and ethylene oxide and/or propylene oxide and/or butylene oxide, or their amino-terminated derivatives which are generally known as Jeffamines®, or trifunctional or higher-functional polyesterols. Particular preference is given to glycerol, trimethylolethane, trimethylolpropane, 1,2,4-butanetriol, pentaerythritol, polyetherols based on glycerol, trimethylolpropane or pentaerythritol, diethanolamine, dipropanolamine and tris(hydroxymethyl)aminomethane.

Examples of (b2) compounds having two groups which are reactive toward isocyanate groups are ethylene glycol, diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, 1,6-hexanediol, neopentyl glycol hydroxypivalate, propane-1,2-dithiol, butane-1,2-dithiol, mercaptoethanol, mercaptopropanol, mercaptobutanol, ethylenediamine, toluenediamine, isophoronediamine, cysteamine, ethanolamine, N-methylethanolamine, 1,2- or 1,3-propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, aminopropanethiol or bifunctional polyetherols or polyesterols, and also bifunctional polyetheramines, generally known as Jeffamines®. Particular preference is given to ethylene glycol, 1,2- and 1,3-propanediol, 1,2-, 1,3- and 1,4-butanediol, ethanolamine, 1,2-propanolamine, mercaptoethanol, 4-hydroxypiperidine and 1-hydroxyethylpiperazine or polyetherols.

The abovementioned Jeffamines® from Huntsman are monoamines, diamines or triamines which are based on polyethers, polyethylene oxides, polypropylene oxides or mixed polyethylene oxides/polypropylene oxides and can have a molar mass up to about 5000 g/mol.

Examples of such monoamines may be found in the Jeffamine® M series, viz. methyl-capped polyalkylene oxides having an amino function, for example i M-600 (XTJ-505) having a propylene oxide (PO)/ethylene oxide (EO) ratio of about 9:1 and a molar mass of about 600, M-1000 (XTJ-506): PO/EO ratio of 3:19, molar mass of about 1000, M-2005 (XTJ-507): PO/EO ratio of 29:6, molar mass of about 2000 or M-2070: PO/EO ratio of 10:31, molar mass of about 2000.

Examples of diamines of this type may be found in the Jeffamine® D or ED series. The D series comprises amino-functionalized polypropylene diols having 3-4 1,2-propylene units (Jeffamine® D-230, mean molar mass=230), 6-7 1,2-propylene units (Jeffamine® D-400, mean molar mass=400), on average about 34 1,2-propylene units (Jeffamine® D-2000) mean molar mass=2000) or on average about 69 1,2-propylene units (Jeffamine® XTJ-510 (D-4000), mean molar mass=4000). Some of these products can also be in the form of amino alcohols. The ED series comprises diamines based on polyethylene oxides which, in idealized form, are propoxylated at both ends, for example Jeffamine® HK-511 (XTJ-511) having 2 ethylene oxide units and 2 propylene oxide units and a mean molar mass of 220, Jeffamine® XTJ-500 (ED-600) having 9 ethylene oxide units and 3.6 propylene oxide units and a mean molar mass of 600 and Jeffamine® XTJ-502 (ED-2003) having 38.7 ethylene oxide units and 6 propylene oxide units and a mean molar mass of 2000.

Examples of triamines are Jeffamine® T-403, viz. a triamine based on trimethylolpropane modified with 5-6 1,2-propylene units, Jeffamine® T-5000, viz. a triamine based on glycerol modified with about 85 1,2-propylene units, and Jeffamine® XTJ-509 (T-3000), a triamine based on glycerol modified with 50 1,2-propylene units.

It is also possible to use mixtures of the compounds mentioned.

In the preparation of the addition product (A), it is necessary to set the ratio of diisocyanate (a1) or polyisocyanate (a2) to compounds (b1) having at least three groups which are reactive toward isocyanate groups or (b2) compounds having two groups which are reactive toward isocyanate groups or mixtures of (b1) and (b2) so that the resulting addition product (A) can comprise isocyanate groups and comprises on average at least one group which is reactive toward isocyanate groups.

For example, in the preparation of the addition product (A) from a diisocyanate (a1) and a trihydric alcohol (b1) the reaction ratio is 2:1, illustrated by the general formula 1, 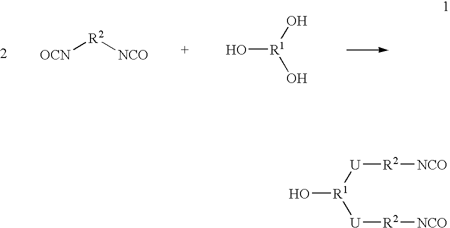
and in the preparation of the addition product (A) from a diisocyanate (a1) and a tetrahydric alcohol as (b1) the reaction ratio is 3:1, illustrated schematically by the general formula 2, 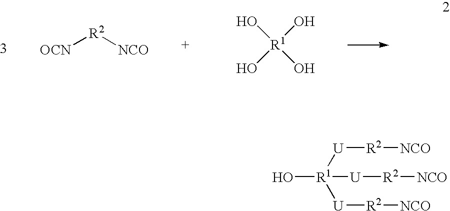
where, in the formulae 1 and 2, R¹ and R² are each an organic radical and U is a urethane group.

Furthermore, the addition product (A) can also be prepared, for example, from a triisocyanate (a2) and a bifunctional component (b2) which is reactive toward isocyanate groups, illustrated by the general formula 3, where the molar reaction ratio is 1:1, R¹ and R² are as defined for the formulae 1 and 2 and Y is, for example, a urea group.

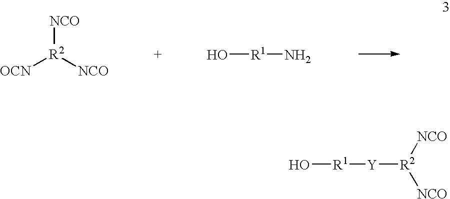

If compounds (b2) having two groups which are reactive toward isocyanate groups are additionally added to the component (b1), this generally results in a lengthening of the chains. As illustrated by way of example in the general formula 4, a further mole of diisocyanate or polyisocyanate (a1) or (a2) (I) has to be added for each mole of the component (b2).

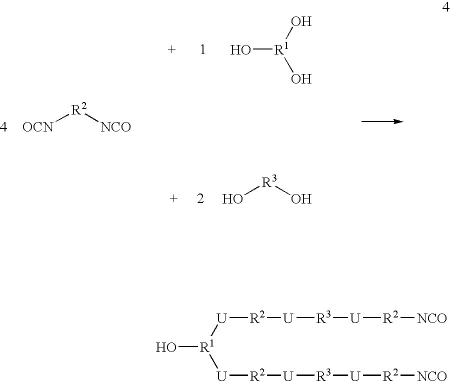

In the formula 4, R³ is an organic radical, and R¹, R² and U are as defined above.

The reaction to form the addition product (A) is usually carried out at a temperature of from −20 to 120° C., preferably at from −10 to 100° C. In a preferred embodiment, the diisocyanate (a1) and/or polyisocyanate (a2) is placed in a reaction vessel and the components (b1) and/or (b2) or the mixture of (b1) and (b2) are/is added. The addition products (A) are often not stable over a prolonged period and are therefore, if desired, preferably reacted immediately with the diisocyanate or polyisocyanate (II).

In a preferred embodiment, the addition product (A) can be converted by means of an intermolecular addition reaction of the addition production (A) into a polyaddition product (P). Here, a group on the addition product (A) which is reactive toward isocyanate groups, if such a group is present, adds onto one of the isocyanate groups of a further addition product (A); particular preference is given to a hydroxy or amino group reacting with an isocyanate group to form a urethane or urea group. The number of addition products (A) which add onto one another to form a polyaddition product (P) is generally not subject to any restrictions. For practical reasons, the addition reaction is usually stopped before the polyaddition product (P) has disadvantageous properties, for example an excessively high viscosity or an unacceptably low solubility, e.g. as a result of an excessively high molecular weight or for steric reasons.

Owing to the nature of the addition products (A), it is possible for various polyaddition products (P) which have branches but essentially no crosslinks to result from the addition reaction. Furthermore, the polyaddition products (P) have more than two isocyanate groups and can have one or more groups which are reactive toward isocyanate groups. The number of isocyanate groups is determined by the nature of the addition products (Al used and the degree of polyaddition.

For example, an addition product (A) of the general formula I can react by triple intermolecular addition to form two different polyaddition products (P) which are represented by the general formulae 5 and 6.

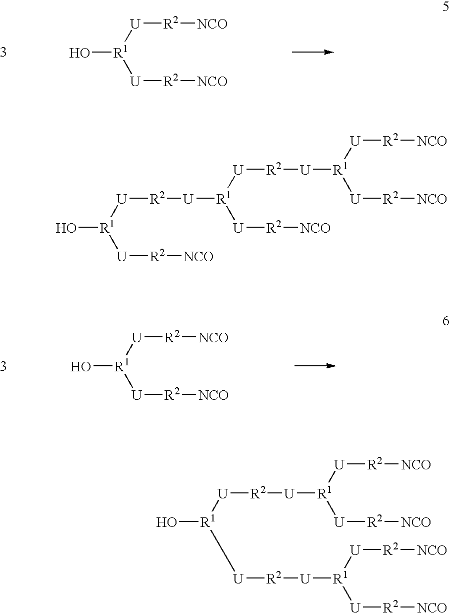

In the formulae 5 and 6, R¹ R² and U are as defined above.

The intermolecular polyaddition reaction of an addition product (A) to form a polyaddition product (P) can usually and preferably be carried out in-situ after the reaction to form the addition product (A) is complete by increasing the temperature, provided that the addition product has at least one, preferably precisely one, group which is reactive toward isocyanate groups.

Furthermore, it is also possible to control the intermolecular polyaddition reaction either by addition of a suitable catalyst or by choice of a suitable temperature.

The reaction can also be accelerated by addition of a suitable catalyst or a suitable catalyst mixture. Suitable catalysts are generally compounds which catalyze urethane reactions, for example amines, ammonium compounds, organic aluminum, tin, titanium, zirconium or bismuth compounds or cesium compounds.

Examples which may be mentioned are diazabicyclooctane (DABCO), diazabicyclononene (DBN) and diazabicycloundecene (DBU), titanium tetrabutoxide, dibutyltin dilaurate, zirconium acetylacetonate or mixtures thereof.

Preferred Lewis-acid organic met-a compounds are dimethyltin diacetate, dibutyltin dibutyrate, dibutyltin bis(2-ethylhexanoate), dibutyltin dilaurate, dioctyltin dilaurate, zirconium acetylacetonate and zirconium 2,2,6,6-tetramethyl-3,5-heptanedionate.

Possible cesium compounds are compounds in which the following anions are used: F³¹ , Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₈O²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, CₙH₂ₙ₋₃O₂)⁻ and (Cₙ₊₁H₂ₙ₋₂O₄)²⁻, where n is from 1 to 20.

Preference is given to cesium carboxylates in which the anion has one of the formulae (CₙH₂ₙ₋₁O₂)⁻ and (Cₙ₊₁H₂ₙ₋₂O₄)²⁻, where n is from 1 to 20. Particular prefer to cesium salts in which the anions are monocarboxylates of the general formula (CₙH₂ₙ₋₁O₂)⁻, where n is from 1 to 20. Here, particular mention may be made of formate, acetate, propionate, hexanoate and 2-ethylhexanoate.

The catalyst is generally added in an amount of from 50 to 10 000 ppm by weight, preferably from 100 to 5000 ppm by weight, based on the amount of isocyanate used.

There are various possible ways of terminating the intermolecular polyaddition reaction. For example, the temperature can be reduced to a region in which the addition reaction stops and the addition product (A) or the polyaddition product (P) is storage-stable.

In a preferred embodiment, a monoisocyanate or a diisocyanate or polyisocyanate (II) is added to the polyaddition product (P) to stop the polyaddition reaction as soon as the intermolecular addition reaction of the addition product (A) has formed a polyaddition product (P) having the desired degree of polyaddition, Reaction of the polyaddition product (P) with the monoisocyanate or the diisocyanate or polyisocyanate (II) gives the high-functionality polyisocyanates of the invention.

If, for example, a diisocyanate (II) is reacted with a polyaddition product (P) of the general formula 5 in a ratio of (P):(II) 2:1, a high-functionality polyisocyanate according to the invention of the general formula 7 can be obtained.

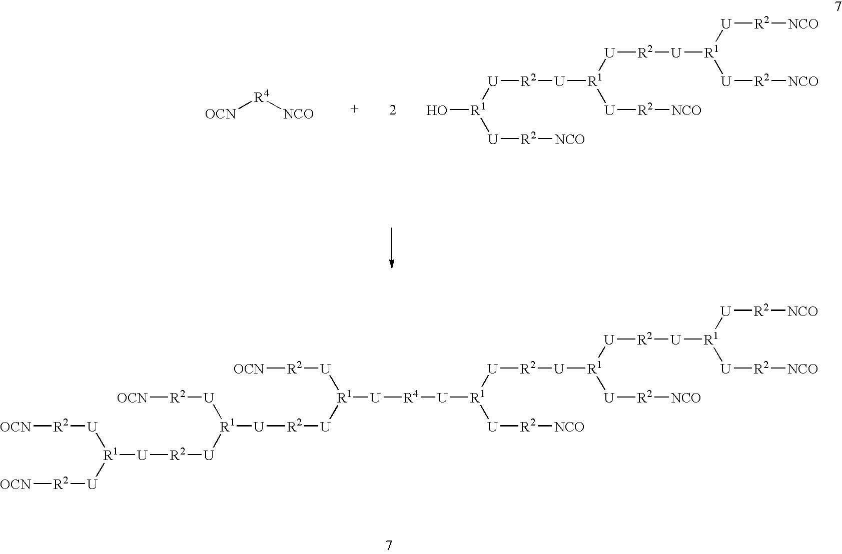

In the formula 7, R¹, R² and U are as defined above and R⁴ is an organic radical which is preferably not identical to R².

As an alternative, the diisocyanate or polyisocyanate (II) can also be added to an addition product (A) which has not yet been converted into a polyaddition product (P) in an intermolecular addition reaction.

However, it is usually advantageous in industry to carry out the intermolecular addition reaction to at least a small extent since small amounts of diisocyanate or polyisocyanate (I) may still be comprised as impurity in the addition product (A) and can then be incorporated into the polyaddition product (P) by means of the intermolecular polyaddition reaction.

The polyisocyanates prepared by the process described can be freed of any solvents or diluents present and/or preferably of excess, unreacted (cyclo)aliphatic diisocyanates (I) in a manner known per se, for example by thin film distillation at a temperature of from 100 to 180° C., if appropriate under reduced pressure, if appropriate with additional passage of inert stripping gas, or extraction, so that the polyisocyanates are obtainable with a content of monomeric diisocyanates of, for example, less than 1.0% by weight, preferably less than 0.5% by weight, particularly preferably less than 0.3% by weight, very particularly preferably less than 0.2% by weight and in particular not more than 0.1% by weight.

In the reaction of the addition product (A) and/or the polyaddition product (P) with the diisocyanate or polyisocyanate (II), it is usual for at least one isocyanate group of the diisocyanate or polyisocyanate (II) to be reacted with the isocyanate-reactive group of the addition product (A) or the polyaddition product (P). In a preferred embodiment, at least 10%, in particular at least 40% and particularly preferably 50-100% of the free isocyanate groups of the diisocyanate or polyisocyanate (II) are reacted with a corresponding number of equivalents of an addition product (A) and/or polyaddition product (P) to form the high-functionality polyisocyanate of the invention.

In a further embodiment, one isocyanate group of a diisocyanate or polyisocyanate (II) is initially reacted with an addition product (A1) or a polyaddition product (P1), and a further isocyanate group of the diisocyanate or polyisocyanate (II) is subsequently reacted with an addition product (A2) or a polyaddition product (P2), with the addition products (A1) and (A2) or the polyaddition products (P1) and (P2) not being identical In this embodiment preference is given to using a diisocyanate or polyisocyanate (II) which has isocyanate groups having differing reactivities toward the isocyanate-reactive groups of the components (A) and/or (P)

The preparation of the high-functionality polyisocyanates of the invention is usually carried out in solvents. Here, it is generally possible to use all solvents which are inert toward the respective starting materials. Preference is given to using organic solvents such as diethyl ether, tetrahydrofuran, acetone, 2-butanone, methyl isobutyl ketone, ethyl acetate, butyl acetate, benzene, toluene, chlorobenzene, xylene, methoxyethyl acetate, methoxypropyl acetate, dimethylformamide, dimethylacetamide or solvent naphtha.

Further examples are ketones such as acetone, 2-butanone, 2-pentanone, 3-pentanone, hexanone, isobutyl methyl ketone, heptanone, cyclopentanone, cyclohexanone and cycloheptanone.

Further examples are ethers such as dioxane or tetrahydrofuran; examples of esters are alkoxyalkyl carboxylates such as triethylene glycol diacetate, butyl acetate, ethyl acetate, 1-methoxyprop-2-yl acetate, propylene glycol diacetate; it is also possible to use 2-butanone or 4-methyl-2-pentanone.

Particular preference is given to monoalkylated or multiply alkylated benzenes and naphthalenes and also mixtures thereof.

As aromatic hydrocarbon mixtures, preference is given to those which comprise predominantly aromatic C₇-C₁₄-hydrocarbons and can comprise a boiling range of from 110 to 300° C.; particular preference is given to toluene, o-, m- or p-xylene, trimethylbenzene isomers, tetramethylbenzene isomers, ethylbenzene, cumene, tetrahydronaphthalene and mixtures comprising these.

Examples are the Solvesso® grades from ExxonMobil Chemical, in particular Solvesso® 100 (CAS No. 64742-95-6, predominantly C₉- and C₁₀-aromatics, boiling range about 154-178° C.), 150 (boiling range about 132-207° C.) and 200 (CAS No. 64742-94-5) and also the Shellsol® grades from Shell. Hydrocarbon mixtures comprising paraffins, cycloparaffins and aromatics are also commercially available under the names Kristallöl (for example Kristallöl 30, boiling range about 158-198° C. or Kristallöl 6 0: CAS No 64742-82-1), white spirit (for example likewise CAS No. 64742-82-1) or solvent naphtha (light: boiling range about 155-180° C., heavy: boiling range about 225-300° C.). The aromatics content of such hydrocarbon mixtures is generally greater than 90% by weight, preferably greater than 95% by weight, particularly preferably greater than 98% by weight and very particularly preferably greater than 99% by weight. It can be useful to use hydrocarbon mixtures having a particularly reduced naphthalene content.

Also conceivable are trimethyl phosphate, tri-n-butyl phosphate and triethyl phosphate or any mixtures of these compounds.

The preparation of the high-functionality polyisocyanates of the invention is usually carried out in a pressure range from 2 mbar to 20 bar, preferably at atmospheric pressure, in reactors or reactor cascades which can be operated batchwise, semicontinuously or continuously.

As a result of the abovementioned setting of the reaction conditions and, if appropriate, by choice of a suitable solvent, the products prepared according to the invention can be processed further after their preparation without further purification.

The isocyanate groups of the high-functionality polyisocyanates of the invention can also be present in capped form. Suitable capping agents for NCO groups are, for example, oximes, phenols, imidazoles, triazoles, pyrazoles, pyrazolinones, diketopiperazines, caprolactam, malonic esters or compounds mentioned in the publications by Z. W. Wiks, Prog. Org. Coat. 3 (1975), 73-99 and Prog. Org. Coat. 9 (1981),3-28, and in Houben-Wey, Method der Organischen Chemie, Volume XIV/2, 61 ff., Georg Thieme Verlag, Stuttgart 1963 or tert-butylbenzylamine as described, for example, in DE-A1 102 26 925

In step (v), the addition product (A) and/or the polyaddition product (P) from one of the preceding steps is reacted with a monofunctional polyalkylene oxide polyether alcohol which is obtainable by alkoxylation of suitable starter molecules. The step (v) can, if desired, also be carried out prior to step (iii) or (iv).

Suitable starter molecules for preparing monohydric polyalkylene oxide polyether alcohols are thiol compounds, monohydroxy compounds of the general formula
R⁵—O—H
or secondary monoamines of the general formula
R⁶R⁷N—H
where

R⁵, R⁶ and R⁷ are each, independently of one another, C₁-C₁₈-alkyl, C₂-C₁₈-alkyl which may optionally be interrupted by one or more oxygen and/or sulfur atoms and/or one or more substituted or unsubstituted imino groups, C₆ -C₁₂-aryl, C₅-C₁₂-cycloalkyl or a five- or six-membered, oxygen-, nitrogen- and/or sulfur-containing heterocycle or R⁶ and R⁷ together form an unsaturated, saturated or aromatic ring which may optionally be interrupted by one or more oxygen and/or sulfur atoms and/or one or more substituted or unsubstituted imino groups, where the radical mentioned may each be substituted by functional groups, aryl, alkyl aryloxy, alkyloxy, halogen, heteroatoms and/or helerocycles.

Preference is given to R⁵, R⁶ and R⁷ each being, independently of one another, C₁-C₄-alkyl, i.e. methyl, ethyl, isopropyl, n-propyl, n-butyl, isobutyl, sec-butyl or tert-butyl. R⁵, R⁶ and R⁷ are each particularly preferably methyl.

Examples of suitable monofunctional starter molecules are saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanoyl, n-octadecanol, cyclohexanol, cyclopentanol, the isomeric methylcyclohexanols or hydroxymethylcyclohexane, 3-ethyl-3-hydroxymethyloxetane or tetrahydrofurfuryl alcohol; unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol; secondary monoamines such as dimethylamine, diethylamine, dipropylamine, diisopropylamine, di-n-butylamine, diisobutylamine, bis(2-ethylhexyl)amine, N-methylcyclohexylamine and N-ethylcyclohexylamine or dicyclohexylamine, heterocyclic secondary amines such as morpholine, pyrrolidine, piperidine or 1H-pyrazole, and also amino alcohols such as 2-dimethylaminoethanol, 2-diethylaminoethanol, 2-diisopropylaminoethanol, 2-dibutylaminoethanol, 3-(dimethylamino)-1-propanol or 1-(dimethylamino)-2-propanol.

Alkylene oxides suitable for the alkoxylation reaction are ethylene oxide, propylene oxide, isobutylene oxide, vinyloxirane and/or styrene oxide, which can be used in any order or in admixture in the alkoxylation reaction.

Preferred alkylene oxides are ethylene oxide, propylene oxide and mixtures thereof, with particular preference being given to ethylene oxide,

Preferred polyether alcohols are ones based on polyalkylene oxide polyether alcohols in whose preparation saturated aliphatic or cycloaliphatic alcohols of the abovementioned type have been used as starter molecules. Very particular preference is given to those based on polyalkylene oxide polyether alcohols which have been prepared using saturated aliphatic alcohols having from 1 to 4 carbon atoms in the alkyl radical. Especial preference is given to methanol-initiated polyalkylene oxide polyether alcohols.

The monohydric polyalkylene oxide polyether alcohols generally have on average at least 2 alkylene oxide units, preferably 5 ethylene oxide units, per molecule, particularly preferably at least 7, very particularly preferably at least 1 0 and in particular at least 15.

The monohydric polyalkylene oxide polyether alcohols generally have on average up to 50 alkylene oxide units, preferably ethylene oxide units, per molecule, preferably up to 45, particularly preferably up to 40 and very particularly preferably up to 30.

The molecular weight of the monohydric polyalkylene oxide polyether alcohols is preferably up to 4000 g/mol, particularly preferably not above 2000 g/mol, very particularly preferably not below 500 g/mol and in particular 1000±200 g/mol.

Preferred polyether alcohols are thus compounds of the formula
R⁵—O—[—Xᵢ—]ₖ—H
where

R⁵ is as defined above,

k is an integer from 5 to 40, preferably from 7 to 45 and particularly preferably from 10 to 40, and

each Xᵢ for i=1 to k can be selected independently from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh—O— and —CHPh—CH₂—O—, preferably from the group consisting of —CH₂—CH₂—O—, —CH₂—CH(CH₃)—O— and —CH(CH₃)—CH₂—O—, and particularly preferably —CH₂—CH₂—O—, where Ph is phenyl and Vin is vinyl.

To carry out step (v), the starting components (A) and/or (P) are reacted with one another at temperatures of from 40 to 180° C., preferably from 50 to 150° C., and at an NCO/OH equivalence ratio of from 1:1 to 100:1, preferably from 1:1 to 50:1, particularly preferably from 1.5:1 to 20:1.

The material used for step (v) has to have NCO groups. It preferably has an NCO number in accordance with DIN 53185 of at least 1% by weight, particularly preferably at least 2% by weight and very particularly preferably at least 5% by weight.

The isocyanate groups present in the addition product (A) or polyaddition product (P) are preferably reacted with a polyether alcohol to an extent of up to 50%, particularly preferably up to 40%, very particularly preferably up to 30%, in particular up to 25% and especially up to 20%. The isocyanate groups present are reacted to an extent of at least 1 mol %, preferably at least 2 mol %, particularly preferably at least 3 mol %, very particularly preferably at least 4 mol %, in particular at least 5 mol % and especially at least 7 mol %.

The reaction time is generally from 10 minutes to 5 hours, preferably from 15 minutes to 4 hours, particularly preferably from 20 to 180 minutes and very particularly preferably from 30 to 120 minutes.

To accelerate the reaction, suitable catalysts can be used if apprprate.

These are the usual catalysts known for these purposes, for example metal carboxylates, metal chelates or tertiary amines of the type described in GB-A-0 994 890, alkylating agents of the type described in U.S. Pat. No. 3,769,318 or strong acids as described by way of example in EP-A-0 000 194.

Suitable catalysts are, in particular, zinc compounds such as zinc(II) stearate, zinc(II) n-octanoate, zinc(II) 2-ethylhexanoate, zinc(II) naphthenate or zinc(II) acetviacetonate, tin compounds, such as tin(II) n-octanoate, tin(II) 2-ethylhexanoate, tin(II) laurate. dibutyltin oxide, dibutyltin dichloride, dibutyltin diacetate, dibutyltin dilaurate, dibutyltin dimaleate or dioctyltin diacetate, aluminum tri(ethylacetoacetate), iron(III) chloride, potassium octoate, manganese, cobalt or nickel compounds and also strong acids such as trifluoroacetic acid, sulfuric acid, hydrogen chloride, hydrogen bromide, phosphoric acid or perchloric acid, or any mixtures of these catalysts.

Furthermore, the catalysts used above for catalyzing the urethane formation reaction can also be used here, with preference being given to alkali metal hydroxides and carboxylates, particularly preferably sodium and potassium hydroxide and carboxylate, very particularly preferably sodium and potassium hydroxide and acetate and in particular potassium hydroxide and potassium acetate,

Depending on the catalyst used, allophanate groups can also be formed.

The reaction for preparing the polyurethane preparation of the invention can also be carried out in the presence of cesium salts, as described in D, 10161156. Preferred cesium salts are compounds in which the following anions are used, F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, where n is from 1 to 20.

Preference is given to cesium carboxylates in which the anion has one of the formulae (CₙH₂ₙ₋₁O₂)⁻ and (Cₙ₊₁H₂ₙ₋₂O₄)²⁻, where n is from 1 to 20. Very particular given to cesium salts in which the anions are monocarboxylates of the general formula (CₙH₂ₙ₋₁O₂)—, where n is from 1 to 20. Here, particular mention may be made of formate, acetate, proponate, hexanoate and 2-ethylhexanoate.

The cesium salts are used in amounts of from 0.01 to 10 mmol of cesium salt per kg of solvent-free batch. They are preferably used in amounts of from 0.05 to 2 mmol of cesium salt per kg of solvent-free batch.

The cesium salts can be added to the batch in solid form, but are preferably added in dissolved form. Suitable solvents are polar, aprotic solvents or else protic solvents.

Suitable, although less preferred, catalysts for the process also include the catalysts described, for example, in EP-A-0 649 866 page 4, line 7, to page 5, line 15.

Preferred catalysts for the process of the invention are zinc compounds of the abovementioned type. Very particular preference is given to the use of zinc(II) n-octanoate, zinc(II) 2-ethylhexanoate and/or zinc(II) stearate. Very particular preference is given to using dibutyltin dilaurate,

These catalysts are, if they are used, employed in an amount of from 0.001 to 5% by weight, preferably from 0.005 to 1% by weight, based on the total weight of the reactants.

They can be added to the reaction mixture by any desired methods. For example it is possible to mix any catalyst to be used into the polyisocyanate component (A), (P) and/or the polyether alcohol prior to commencement of the actual reaction. It is likewise possible to add the catalyst the reaction mixture at any point in time during the reaction or, in a two-stage reaction, after the urethane formation reaction, i.e. when the NCO content which corresponds theoretically to complete reaction of isocyanate and hydroxy groups has been reached.

If a catalyst for catalyzing the reaction is comprised in the starting material used, the addition of catalyst can be entirely partly omitted. This i s the case, for example, when the reaction in step ;i) has been catalyzed by means of a suitable catalyst and this is still comprised in the reaction mixture used in step (v). Furthermore, it is conceivable for the polyether alcohol used still to comprise small amounts of, for example, potassium hydroxide or potassium acetate which catalyze the preparation of the polyether alcohol or are used or formed in its work-up and are still present in the product.

The order in which the components (A), (P) and polyether alcohol are mixed is unimportant for the purposes of the invention; for example, the components can be mixed with one another simultaneously at least part of the polyether alcohol can be initially charged and (A) and/or (P) can be added thereto or at least pa of (A) or (P) is initially charged, polyether alcohol is added thereto and the last component is add ed to this mixture.

The course o the reaction can be followed by, for example titrimetric determination of the NCO content in accordance with DIN 53185. After the desired NCO content has been re ached, he reaction is stopped. This can, in the case of a purely thermal reaction procedure, be effected, for example, by cooling the reaction mixture to room temperature. When a catalyst of the abovementioned type is used, the reaction is generally stopped by addition of suitable deactivators. Suitable deactivators are, for example, inorganic or organic acids, the corresponding acid halides and alkylating agents. Examples which may be mentioned are phosphoric acid, monochloroacetic acid, dodecylbenzenesulfonic acid, benzoyl chloride, dimethyl sulfate and preferably dibutyl phosphate and also di-2-ethylhexyl phosphate. The deactivating agents can be used in amounts of from 1 to 200 mol %, preferably from 20 to 100 mol %, based on the number of moles of catalyst.

The resulting polyisocyanate mixtures generally have an NCO content of preferably from 2.0 to 23.0% by weight, particularly preferably from 4.0 to 22.0% by weight. The resulting polycsocyanate mixtures generally have a viscosity at 23° C. of up to 50 Pas, preferably up to 40 Pas, particularity preferably up to 30 Pas, very particularly preferably up to 20 Pas and in particular up to 15 Pas.

The resulting polyisocyanate mixtures generally have a viscosity at 23° C. of at least 0.2 Pas, preferably at least 0.3 Pas, particularly preferably at least 1 Pas, very particularly preferably at least 2 Pas and in particular at least 5 Pas,

The resulting polyisocyanate mixtures can also be solid. In this case, they can, for example, be liquefied by heating to a temperature above the glass transition temperature or be used as a solution in a suitable solvent, for example in one of the abovementioned solvents, preferably in butyl acetate, butanone, isobutyl methyl ketone, methoxypropyl acetate, acetone or ethyl acetate.

The process can, if appropriate, be carried out in a suitable solvent which is inert toward isocyanate groups. Suitable solvents are, for example, the customary surface coating solvents known per se, e.g. ethyl acetate, butyl acetate, ethylene glycol monomethyl or monoethyl ether acetate, 1-methoxypropyl 2-acetate, 3-methoxy-n-butyl acetate, acetone, 2-butanone, isobutyl methyl ketone, 4-methyl-2-pentanone, cyclohexanone, cyclopentanone, toluene, xylene, chlorobenzene, petroleum spirit, relatively highly substituted aromatics as are commercially available under the trade names Solvent naphtha®, Solvesso®, Shellsol®, Isopar®, Nappar® and Diasol®, propylene glyol diacetate, diethylene glycol dimethyl ether, dipropylene glycol dimethyl ether, diethylene glycol ethyl and butyl ether acetate, N-methylpyrrolidone and N-methylcaprolactam, and preferably carbonic esters or lactones as are mentioned in EP-A1 697 424, p, 4, lines 4 to 32 particularly preferably dimethyl carbonate, dimethyl carbonate, 1,2-ethylene carbonate and 1,2-propylene carbonate, lactones such as β- or propiolactone, γ-butyrolactone, ε-caprolactone and ε-methylcaprolactone, or else any mixtures of such solvents.

It is also possible to carry out the preparation of the isocyanates of the invention initially without a solvent and subsequently take up the resulting product in a solvent.

The dispersible particles prepared using the polyisocyanates of the invention generally have a mean particle size (z average), measured by means of dynamic light scattering using the Malvern® Autosizer 2 C, of generally <1000 nm, preferably <500 nm and particularly preferably <100 nm. The diameter is normally from 20 to 80 nm.

To prepare the dispersions using polyisocyanates according to the invention, simple dispersing techniques, e.g. using a mechanical stirrer, for example a disk, inclined blade, anchor, high-speed or sparging stirrer, or often simple mixing of the two components by hand or by shaking are in most cases adequate for obtaining dispersions having very good properties. Of course, it is also possible to use mixing techniques which introduce a high shear energy, e.g. jet dispersion, high-speed, Ultraturrax or ultrasonic dispersion

The mixtures according to the invention can of course be mixed with customary auxiliaries and additives used in surface coatings technology. These include, for example, antifoams, thickeners, leveling agents, pigments, emulsifiers, dispersants and solvents. The desired processing viscosity is set by addition of water.

The present invention further provides for the use of the water-dispersible, high-functionality, highly branched or hyperbranched polyisocyanates of the invention in a polyurethane dispersion and also provides this polyurethane dispersion. In a preferred embodiment, this polyurethane dispersion can be blended with further low-viscosity polyisocyanates, preferably polyisocyanates having a viscosity of up to 1200 mPas, particularly preferably polyisocyanates having a viscosity of up to 700 mPas and very particularly preferably polyisocyanates having a viscosity of up to 300 mPas. As such polyisocyanates, it is possible to use all aliphatic, cycloaliphatic and aromatic isocyanates known from the prior art, in particular those having allophanate, isocyanurate and/or asymmetric isocyanurate groups.

As reaction partners for the water-dispersible, high-functionality, highly branched or hyperbranched polyisocyanates of the invention in coating compositions or polyurethane dispersions, preference is given to using polyacrylate polyols, polyesterois and/or polyetherols. In a particularly preferred embodiment, these polyacrylate polyols, polyesterols and/or polyetherols can be in the form of dispersions, for example as primary or secondary dispersions. For example they can comprise dispersed polyol components as are described in DE-A1 42 06 044, p. 3, line 1, to p. 4, line 30, which is hereby expressly incorporated by reference.

Such polyacrylate polyols, polyesterols and/or polyetherols in primary dispersions preferably have a molecular weight Mₙ of at least 500 g/mol, particularly preferably at least 1000 g/mol, very particularly preferably at least 2000 g/mol and in particular at least 5000 g/mol. The molecular weight Mₙ can be, for example, up to 200 000 g mol, preferably up to 100 000 g/mol, particularly preferably up to 80 000 g/mol and very particularly preferably up to 50 000 g/mol.

In the case of secondary dispersions, the molecular weight can be, for example, up to 1 500 000 g/mol, preferably up to 1 200 000 g/mol, particularly preferably up to 1 000 000 g/mol.

The coating compositions comprising the mixtures according to the invention can be used, in particular, as primers, fillers, pigmented topcoats or clear varnishes in industrial surface coating, in particular surface coatings for aircraft or large vehicles, surface coating of wood, motor vehicles, in particular in OEM or automobile repair coating, or decorative surface coating. The coating compositions are particularly useful for applications in which a particularly high application reliability, exterior weathering resistance, optical appearance and resistance to solvents and/or chemicals are required.

The pot lives of the coating composition or polyurethane dispersions of the invention is generally at least 4 hours particularly preferably at least 8 hours.

Drying and curing of the coatings is generally carried out under normal temperature conditions, i.e. without heating of the coating. However, the mixtures according to the invention can also be used for producing coatings which are dried and cured at elevated temperature, e.g. at 40-250° C., preferably 40-150° C. and in particular from 40 to 100° C. after application.

Substrates which can be coated are any substrates, preferably wood, paper, textiles, leather, nonwovens, polymer surfaces, glass, ceramic, mineral building materials such as molded cement blocks and fibrocement sheets, or metals or coated metals, particularly preferably polymers or metals which, for example, can also be in the form of films or foils,

Coating of the substrates is carried out by customary methods known to those skilled in the art with at least one dispersible resin according to the invention in a surface coating formulation being applied in the desired thickness to the substrate to be coated and the volatile constituents of the dispersion being removed, if appropriate with heating. This procedure can, if desired, be repeated one or more times. The coating compositions comprising the polyisocyanates of the invention can be applied by a variety of spray processes, e.g. pressurized air, airless or electrostatic spraying processes using single- or two-component spraying units, or else by spraying, trowel application, doctor blade coating, brushing, rolling, calendering, casting, lamination, back-spraying or coextrusion. The coating thickness is generally in a range from about 3 to 1000 g/m² and preferably from 10 to 200 g/m².

The following examples illustrate the subject matter of the invention, but do not restrict its scope

### EXAMPLES

High-Functionality, Highly Branched or Hyperbranched Polyisocyanates:

Polyisocyanate X1:

333 g of isophorone diisocyanate (IPDI) were placed in a reaction vessel equipped with stirrer, reflux condenser, gas inlet tube and dropping funnel under a blanket of nitrogen and 100 g of trimethylolpropane (TMP) dissolved in 433 g of dry acetone were added over a period of 1 minute while stirring well. After addition of 0.1 g of dibutyltin dilaurate, the reaction mixture was heated to 60° C. while stirring and the decrease in the NCO content was monitored titrimetrically in accordance with DIN 53185. When an NCO content of 5.4% by weight had been reached, 167 g of BASONAT® HA 300 dissolved in 167 g of dry acetone were added and the mixture was stirred at 60° C. for another 30 minutes. The end product had an NCO content of 5.8% by weight.

Polyisocyanate X2:

500 g of isophorone diisocyanate (IPDI) were placed in a reaction vessel equipped with stirrer, reflux condenser, gas inlet tube and dropping funnel under a blanket of nitrogen and 150 g of trimethylolpropane (TMP) dissolved in 650 g of dry ethyl acetate were added over a period of 1 minute while stirring well. After addition of 0.2 g of dibutyltin dilaurate, the reaction mixture was heated to 40° C. while stirring and the decrease in the NCO content was monitored titrimetrically in accordance with DIN 53185. When an NCO content of 7.2% by weight had been reached, 1250 g of BASONAT® HA 300 were added, the mixture was heated to 60° C. and stirred at this temperature for 1 hour, Ethyl acetate was subsequently removed on a rotary evaporator at 60° C. and 8 mbar. The end product had an NCO content of 14.6% by weight.

Polyisocyanate X3:

500 g of isophorone diisocyanate (IPDI) were placed in a reaction vessel equipped with stirrer, reflux condenser, gas inlet tube and dropping funnel under a blanket of nitrogen and 150 g of trimethylolpropane (TMP) dissolved in 650 g of dry ethyl acetate were added over a period of 1 minute while stirring well After addition of 0.2 g of dibutyltin dilaurate, the reaction mixture was heated to 40° C. while stirring and the decrease in the NCO content was monitored titrimetrically in accordance with DIN 53185. When an NCO content of 7.2% by weight had been reached, 1075 g of BASONAT® HI 100 were added, the mixture was heated to 60° C. and stirred at this temperature for 1 hour. Ethyl acetate was subsequently removed on a rotary evaporator at 60° C. and 8 mbar. The end product had an NCO content of 16.2% by weight.

BASONAT® HA 300, ASF AG: HDI polyisocyanate having a high content of allophanate groups, viscosity: about 350 mPas, solids content=100%, NOC content=19.5% by weight.

BASONAT® HI 100, ASF AG: HDI polyisocyanate having a high content of isocyanurate groups, viscosity at 23° C. (DIN EN ISO 3219)=2500-4000 mPas, solids content=100%, NCO content (DIN EN ISO 11909)=21.5-22.5%.

Polyetherols

Y1=methanol-nitrated monofunctional polyethylene oxide prepared using potassium hydroxide as catalyst and having a mean OH number of 53 mg KOH/g, measured in accordance with DIN 53 240, corresponding to a mean molecular weight of about 1000 g/mol. The basic catalyst residues still present were subsequently neutralized with acetic acid and the product was desalted.

Y2=methanol-initiated monofunctional polyethylene oxide prepared using potassium hydroxide as catalyst and having a mean OH number of 29 mg KOH/g, measured in accordance with DIN 53 240, corresponding to a mean molecular weight of about 2000 g/mol. The basic catalyst residues still present were subsequently neutralized with acetic acid and the product was desalted.

Y3=methanol-initiated monofunctional polyethylene oxide prepared using potassium hydroxide as catalyst and having a mean OH number of 112 mg KOH/g, measured in accordance with DIN 53 240, corresponding to a mean molecular weight of about 500 g/mol. The basic catalyst residues still present were subsequently neutralized with acetic acid. The basicity is determined as 1,06 mmol/kg by titration with HCl.

About 0.12 g of anhydrous p-toluenesulfonic acid was then added to 75 9 of the polyether and the basicity was thus brought to 2 mmol/kg (HCl titration).

Polyisocyanates

Z1=isomer mixture of 80% of tolylene 2,4-diisocyanate and 20% of tolylene 2,6-diisocyanate

Z2=Basonat® HI 100 from BASF AG (see above)

Z3=commercial emulsifier-modified polyisocyanate based on isocyanuratized hexamethylene diisocyanate, NCO content ˜17±0.5% (Basonat® HW 100 from BASF AG),

Z4=commercial emulsifier-modified polyisocyanate based on isocyanuratized hexamethylene diisocyanate, 80% in Solvenon® PC; NCO content ˜13.5±0.5% (Basonat® HW 180 from BASF AG),

### Example 1

40 g of the polyetherol Y2 were added to 250 g of hyperbranched polyisocyanate X1 at room temperature. The reaction solution was stirred for 3 hours at 50-60° C. After a small sample had been taken, it was found that this still settled readily after dispersion in water; for this reason, a further 10 g of the polyetherol Y2 in 150 g of acetone were added. After a further 2 hours, taking of a sample indicated that the product formed a fine emulsion in water which no longer settled.

Removal of the acetone gave a slightly yellowish resin which has a viscosity of 12 000 mPas (23° C.) and an NCO content of 2.95%.

A 67% strength solution of the resin in propylene carbonate was prepared for use in surface coating formulations.

### Example 2

Intermediate—320 g of the polyetherol Y3 were added to 53 g of polyisocyanate Z1, the mixture was stirred under nitrogen at 75-80° C. for 1-2 hours and then cooled to room temperature. A sample indicated that no NCO bands were present in the IR.

88 g of the intermediate were added to a mixture of 400 g of the polyisocyanate Z2 and 100 g of the hyperbranched polyisocyanate X2. After stirring for four hours at 50-70° C., a small sample was taken and this could readily be dispersed in water.

A virtually colorless resin having a viscosity of 7590 mPas (23° C.) and an NCO content of 16.5% was obtained as product,

### Example 3

Intermediate—as in Example 2

88 g of the intermediate from example 2 were added to a mixture of 400 g of the polyisocyanate Z2 and 100 g of the hyperbranched polyisocyanate X3. After stirring for five hours at 50-60° C., a small sample was taken and this could readily be dispersed in water.

A slightly yellowish resin having a viscosity of 8890 mPas (230C) and an NCO content of 16.5% was obtained as product.

### Example 4

56 g of the polyetherol Y1 were added to a mixture of 400 g of the polyisocyanate Z2 and 100 g of the hyperbranched polyisocyanate X2. After stirring for four hours at 70-80° C., a small sample was taken and this could readily be dispersed in water. The product became solid after cooling, and the NCO value was determined as 17.4%.

Use Tests on Surface Coatings:

The polyisocyanates according to the invention and also comparative polyisocyanates (hardeners) were mixed by way of example with an aqueous hydroxy-functional component:

Hydroxy-Functional Component:

1st Stage:

328 g of Plusaqua® V 608 (about 80% strength) OH-functional polyester resin, Omya AG

18 g of AMP 90 [2-amino-2-methyl-1-propanol, 90% in water, Angus-Chemie] amine for neutralization

454 g of deionized water gives:

800 g of hydroxy-functionalized mixture (about 33% strength)

2nd Stage:

240 g of Daotan® (VTW) 1225 (about 40% strength) hydroxy-functionalized, polyester-modified polyurethane dispersion, from Vianova Resins

290 g of hydroxy-functional mixture (about 33% strength, from stage 1)
3 g of AMP 90 (pH 3.6)

107 g of deionized water
16 g of Fluorad® FC 430 (10% strength antifoam, from 3M gives:

656 g of hydroxy-functional component (about 29.3% strength)

The hydroxy-functional component was mixed in the following ratios with the polyisocyanate components The mixture from example 4 was for this purpose diluted with 1,2-propylene carbonate in a ratio of 80:20

| | Example 5 | Example 6 | | | |
|---|---|---|---|---|---|
| | Reference | Reference | Example 7 | Example 8 | Example 9 |
| Hydroxy-functional | 77.3 g | 73.9 g | 67.3 g | 65.1 g | 68.4 g |
| component, 29.3% | | | | | |
| strength | | | | | |
| Polyisocyanate Z3 | 22.7 g | | | | |
| Polyisocyanate Z4 | | 27.1 g | | | |
| Example 2, 100% | | | 19.7 g | | |
| Example 4, 80% | | | | 23.8 g | |
| strength; 20% of | | | | | |
| propylene carbonate | | | | | |
| Example 3, 100% | | | | | 20.0 g |
| strength | | | | | |
| Deionized water | | | 13.0 g | 11.0 g | 11.6 g |
| pH, immediate | | | 8.0 | 8.1 | 8.0 |
| pH after 24 h | | | 8.7 | 6.8 | 6.6 |

Gradated baking sheets were coated (180 μm wet) by means of a film drawing device. The clear coatings obtained in this way were cured at 60-120° C. for 30 minutes in a convection oven, and then allowed to cool under standard conditions of 23° C./50% atmospheric humidity. They gave layer thicknesses of ˜40 μm dry

| Layer | | | | | |
|---|---|---|---|---|---|
| thickness | | | | | |
| after 30 | Example 5 | Example 6 | | | |
| minutes | Reference | Reference | Example 7 | Example 8 | Example 9 |
| 60° C. | ˜40 | ˜40 | 37 | 34 | 39 |
| 70° C. | ˜40 | ˜40 | 37 | 32 | 39 |
| 80° C. | ˜40 | ˜40 | 38 | 35 | 40 |
| 90° C. | ˜40 | ˜40 | 42 | 37 | 41 |
| 100° C. | ˜40 | ˜40 | 38 | 36 | 40 |
| 110° C. | ˜40 | ˜40 | 38 | 35 | 40 |
| 120° C. | ˜40 | ˜40 | 35 | 35 | 40 |

The surface coatings produced using the polyisocyanates according to the invention had a higher (better) hardness than those produced using standard isocyanates (reference examples 5 and 6). In addition, a lower brittleness (cross cutting) compared to reference example 6 was found.

The hardness was determined as pendulum hardness by the method of König (EN ISO 1522). The higher the hardness, the better.

The cross cutting value was determined in accordance with DIN 53151 (0=very good; 5=very brittle).

Pendulum Hardnesses

| | Example 5 | Example 6 | | | |
|---|---|---|---|---|---|
| T/° C. | Reference | Reference | Example 7 | Example 8 | Example 9 |
| 60 | 31 | 25 | 40 | 37 | 31 |
| 70 | 44 | 40 | 53 | 56 | 56 |
| 80 | 48 | 61 | 67 | 72 | 71 |
| 90 | 49 | 80 | 73 | 88 | 85 |
| 100 | 51 | 90 | 87 | 96 | 91 |
| 110 | 52 | 91 | 92 | 101 | 95 |
| 120 | 77 | 93 | 95 | 104 | 101 |

Cross Cutting:

| | Example 5 | Example 6 | | | |
|---|---|---|---|---|---|
| T/° C. | Reference | Reference | Example 7 | Example 8 | Example 9 |
| 60 | 2.5 | 5 | 5 | 3 | 3 |
| 70 | 2 | 5 | 2.5 | 3 | 3 |
| 80 | 0 | 5 | 2.5 | 2.5 | 3 |
| 90 | 0 | 5 | 1 | 2 | 3.5 |
| 100 | 1 | 5 | 1 | 1.5 | 1.5 |
| 110 | 0.5 | 5 | 1 | 1.5 | 1.5 |
| 120 | 0 | 4.5 | 1 | 1.5 | 3 |

In addition, the elasticity of all films was determined as Erichsen cupping index (Erichsen test in accordance with DIN EN ISO 1520). All films gave values above 9. These films are thus to be rated as very elastic according to this test.

In addition, the acetone test was carried out as a measure of the solvent resistance. All films gave at least 100 double strokes.

1. A process for preparing water-dispersible, high-functionality, highly branched or hyperbranched polyisocyanates, wherein said process comprised:
(i) preparation of an addition product (A) comprising one or more isocyanate groups and at least one group which is reactive toward isocyanate groups by reacting a
(I)(a1) diisocyanate and or
(I)(a2) polyisocyanate with
(b1) at least one compound having at least three groups which are reactive toward isocyanate groups and/or
(b2) at least one compound having two groups which are reactive toward isocyanate groups,
where at least one of the components (a) or (b) has functional groups which have differing reactivities toward the functional groups of the other component and
the reaction ratio is selected so that the addition product (A) comprises on average at east one group which is reactive toward isocyanate groups and one or more isocyanate groups,
(ii) if appropriate, intermolecular addition reaction of the addition product (A) or (i) to form a polyaddition product (P) which comprises one or more isocyanate groups and can comprise at least one group which is reactive toward isocyanate groups,
(iii) if appropriate, reaction of the addition product (A) from (i) and/or the polyaddition product (P) from (ii) if this comprises at least one group which is reactive toward isocyanate groups with a monofunctional isocyanate, and or
(iv) if appropriate, reaction of the addition product (A) from (i) an d/or the polyaddition product (P) from (ii) if this comprises at least one group which is reactive toward isocyanate groups with at least one diisocyanate or polyisocyanate (I)(a1) or (I)(a2) and/or at least one diisocyanate or polyisocyanate (II) which is different from the diisocyanate or polyisocyanate (I), and
(v) reaction of the addition product (A) from (i) and/or the polyaddition product (P) from (ii) and or the reaction product from (iii) and/or (iv) with a monofunctional polyalkylene oxide polyether alcohol.

2. The process according to claim 1, wherein the polyisocyanate in (v) has at least three free isocyanate groups.

3. The process according to claim 1, wherein the polyisocyanate in (v) has not more than 100 isocyanate groups.

4. The process according to claim 1, wherein the polyisocyanate in (v) has on average from 0 to 20 groups which are reactive toward isocyanate groups.

5. The process according to claim 1, wherein the polyisocyanate in (v) has a molecular weight M_{w} of not more than 100,000 g/mol.

6. The process according to claim 1, wherein the polyisocyanate in (v) has a polydispersity of from 1.1 to 50.

7. The process according to claim 1, wherein the diisocyanates or polyisocyanates (I) are selected from the group consisting of diphenylmethane 2,4′- and 4,4′-diisocyanate (MDI), mixtures o monomeric diphenylmethane diisocyanates and higher homologues of diphenylmethane diisocyanate (polymeric MDI), tetramethylene diisocyanate, tetramethylene diisocyanate trimers hexamethylene diisocyanate, hexamethylene diisocyanate trimers, isophorone diisocyanate trimer, 2,4′- and 4,4′-methylenebis(cyclohexyl isocyanate), xylylene diisocyanate, tetramethylxylylene diisocyanate, dodecyl diisocyanate, lysin alkyl ester diisocyanate, where alkyl is C₁-C₁₀-alkyl, 2,2,4- or 2,4,4-trimethyl-1,6-hexamethylene diisocyanate, 1,4-diisocyanatocyclohexane, 1,3- or 1,4-bis(isocyanatomethyl cyclohexane, 4-isocyanatomethyl-1,8-octamethylene diisocyanate, tolylene 2,4-diisocyanate (2,4-TDI), triisocyanatotoluene, isophorone diisocyanate (IPDI), 2-butyl-2-ethylpentamethylene diisocyanate, 2-isocyanatopropylcyclohexyl isocyanate, 3(4)-isocyanatomethyl-1-methylcyclohexyl isocyanate 1,4-diisocyanato-4-methylpentane, 2,4′-methylenebis(cyclohexyl isocyanate), 4-methylcyclohexane 1,3-diisocyanate (H-TDI), 1,3- and 1,4-phenylene diisocyanate, 1,5-naphthylene diisocyanate, biphenyl diisocyanate, tolidine diisocyanate and tolylene 2,6-diisocyanate or 3 (or 4), 8 (or 9)-bis(isocyanatomethyl)tricyclo[5.2.1.0^{2.6}]decane isomer mixtures,

8. The process according to claim 1, wherein the compounds (b1) having at least three groups which are reactive toward isocyanate groups are selected from the group comprising glycerol, trimethylolmethane, trimethylolethane, trimethylolpropane, 1,2,4-butanetriol, tris(hydroxymethyl)aminomethane, tris(hydroxyethyl)aminomethane, 2-amino-1,3-propanediol, 2-amino-2-methyl-1,3-propanediol, diethanolamine, dipropanolamine, diisopropanolamine, ethanolpropanolamine, bis(aminoethyl)amine, bis(aminopropyl)amine, tris(aminoethyl)amine, tris(aminopropyl)amine, trisaminononane, tris-(2-hydroxyethyl) isocyanurate, pentaerythitol, dipentaerythritol, bis(trimethylolpropane), sorbitol, mannitol, diglycerol, threitol, erythitol, adonitol (ribitol), arabitol (lyxitol), xylitol, dulcitol (galactitol), maltitol, isomaltitol, glucose, trifunctional or higher-functional polyetherols based on trifunctional or higher-functional starter molecules and ethylene oxide and/or propylene oxide and/or butylene oxide, and their amino-terminated derivatives and trifunctional or higher-functional polyesterols.

9. The process according to claim 1, wherein the compounds (b2) having two groups which are reactive toward isocyanate groups are selected from the group comprising ethylene glycol, diethylene glycol, triethylene glycol, 1,2- and 1,3-propanediol, dipropylene glycol, tripropylene glycol, neopentyl glycol, 1,2-, 1,3- and 1,4-butanediol, 1,2-, 1,3- and 1,5-pentanediol, 1,6-hexanediol, neopentyl glycol hydroxypivalate, propane-1,2-dithiol, butane-1,2-dithiol, mercapto ethanol, mercaptopropanol, mercaptobutanol, ethylenediamine, toluenediamine, isophoronediamine, cysteamine, ethanolamine, N-methylethanolamine, 1,2- and 1,3-propanolamine, isopropanolamine, 2-(butylamino)ethanol, 2-(cyclohexylamino)ethanol, 2-amino-1-butanol, 2-(2′-aminoethoxy)ethanol and higher alkoxylation products of ammonia, 4-hydroxypiperidine, 1-hydroxyethylpiperazine, aminopropanethiol and bifunctional polyetherols and polyesterols and also bifunctional polyetheramines.

10. The process according to claim 1, wherein the monofunctional polyalkylene oxide polyether alcohols are obtainable by alkoxylation of thiol compounds or monohydroxy compounds of the general formula
R⁵—O—H
or secondary monoamines of the general formula
R⁶R⁷N—H,
where R⁵, R⁶ and R⁷ are each, independently of one another, C₁-C₁₈-alkyl, C₂-C₁₈-alkyl which may optionally be interrupted by one or more oxygen and or sulfur atoms and/or one or more substituted or unsubstituted imino groups, C₆-C₁₂-aryl C₅-C₁₂-cycloalkyl or a five- or six-membered, oxygen-, nitrogen- and or sulfur-containing heterocycle or R⁶ and R⁷ together form an unsaturated, saturated or aromatic ring which may optionally be interrupted by one or more oxygen and/or sulfur atoms and/or one or more substituted or unsubstituted imino groups, where the radicals mentioned may each be substituted by functional groups, aryl, alkyl aryloxy, alkyloxy, halogen, heteroatoms and/or heterocycles,
by means of ethylene oxide, propylene oxide, isobutylene oxide, vinyloxirane and/or styrene oxide.

11. The process according to claim 10, wherein he monohydric polyalkylene oxide polyether alcohols have on average at east 2 alkylene oxide units,

12. The process according to claim 10, wherein the monohydric polyalkylene oxide polyether alcohols have on average up to 50 alkylene oxide units.

13. (canceled)

14. A method of preparing a polyurethane dispersion, wherein said method comprises reacting one or more water-dispersible, high-functionality, highly branched or hyperbranched polyisocyanates according to claim 1 with one or more polyols selected from the group consisting of polyacrylate polyols, polyesterols, and polyetherols.

15. A polyurethane dispersion comprising:
one or more water-dispersible, high-functionality, highly branched or hyperbranched polyisocyanates according to claim 1; one or more polyols selected from the group consisting of polyarcylate polyols, polyesterols, and polyetherols; and
optionally one or more polyisocyanates having a viscosity of up to 1200 mPas.

16. A coating composition comprising one or more water-dispersible, high-functionality, highly branched or hyperbranched polyisocyanates according to claim 1.

17. A method of coating a substrate with the coating composition according to claim 16, wherein said method comprises applying said coating composition to said substrate, wherein said coating composition is selected from the group consisting of a coating, a primer, a paint, a topcoat, a varnish, an adhesive, a sealant, a filler, a foam, and a pourable elastomer.

18. The method according to claim 17, wherein said substrate is selected from the group consisting of wood, paper, leather, textiles, nonwovens, polymers, glass, ceramics, cement building materials, metals, aircraft, and vehicles.
